(19) United States
(12) Patent Application Publication
(10) Pub. No.: US 2013/0166806 A1
(43) Pub. Date: Jun. 27, 2013

(54) PCI RISER CARD

(71) Applicants: YIN-HU WU, Wuhan City (CN); TAI-BAO WU, Wuhan City (CN); RONG-RONG SONG, Wuhan City (CN); QIU-HUA PENG, Wuhan City (CN)

(72) Inventors: YIN-HU WU, Wuhan City (CN); TAI-BAO WU, Wuhan City (CN); RONG-RONG SONG, Wuhan City (CN); QIU-HUA PENG, Wuhan City (CN)

(73) Assignees: HON HAI PRECISION INDUSTRY CO., LTD., Tu-Cheng, (TW); HONG FU JIN PRECISION INDUSTRY (WUHAN) CO., LTD., Wuhan City (CN)

(21) Appl. No.: 13/535,439

(22) Filed: Jun. 28, 2012

(30) Foreign Application Priority Data
Dec. 27, 2011 (CN) 201110443673.0

(51) Int. Cl. G06F 13/14

(52) U.S. Cl. 710/301

(57) ABSTRACT

A PCI riser card includes a printed circuit board and an array of PCI connectors located on the printed circuit board. A plug portion extends from an edge of the printed circuit board and may be inserted into a PCI connector of a system board. The array of PCI connectors includes a first PCI connector and a second PCI connector. The first PCI connector is parallel to the second PCI connector is arranged in inverse relative to the second PCI connector.

### BACKGROUND

1. Technical Field

The present disclosure generally relates to a PCI riser card, and particularly relates to a PCI riser card with a mistake-proof design.

2. Description of Related Art

PCI riser cards are often used to provide additional PCI slots for adding PCI expansion cards to a system board (also known as a mainboard) enclosed in a system case. Because the PCI riser cards rise above the system board, the PCI riser cards allow connecting additional PCI expansion cards to the system board in an orientation that is parallel to the system board and save space within the system case.

FIGS. 1 and 2 illustrate a conventional PCI riser card P10 and a conventional PCI expansion card P20. The PCI riser card P10 includes a printed circuit board P11 and PCI connectors P13, P14, and P15 located on the printed circuit board P11. The PCI connectors P13, P14, and P15 are parallel to each other and all have a same slot arrangement. Thus, the PCI expansion card P20 may be inserted into any one of the PCI connectors P13, P14, and P15. However, it may be that the PCI expansion card P20 should only be inserted into a specific one of the connectors to function properly, and it is very easy for a user to mistakenly insert the PCI expansion card into a wrong connector.

Therefore, there is a need to provide a PCI riser card which requires that a specific PCI expansion card can only be inserted into a specific PCI connector among several connectors.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a conventional PCI riser card and a conventional PCI expansion card.

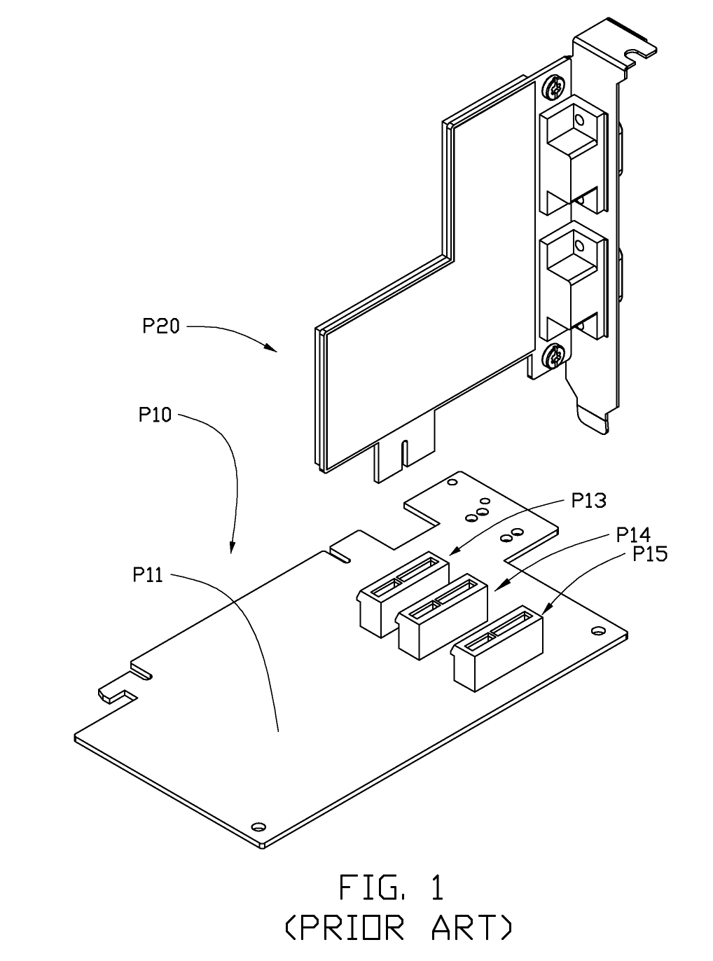

FIG. 2 is an isometric view of an assembly of the conventional PCI riser card and the conventional PCI expansion card of FIG. 1.

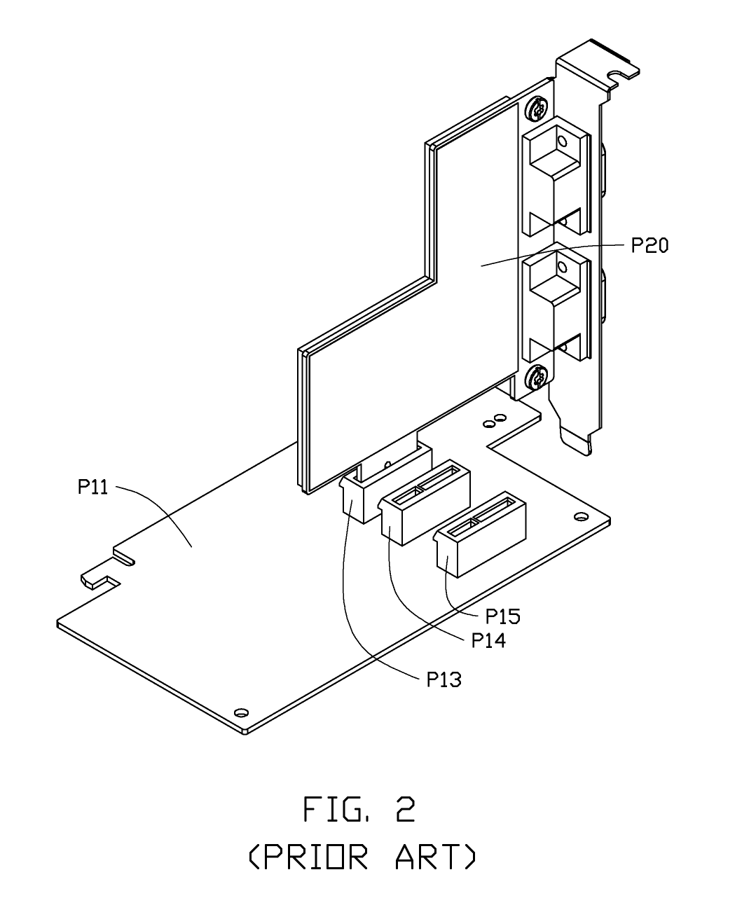

FIG. 3 is an isometric view of a PCI riser card and a PCI expansion card in accordance with an embodiment.

FIG. 4 is an isometric view of an assembly of the PCI riser card and the PCI expansion card of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

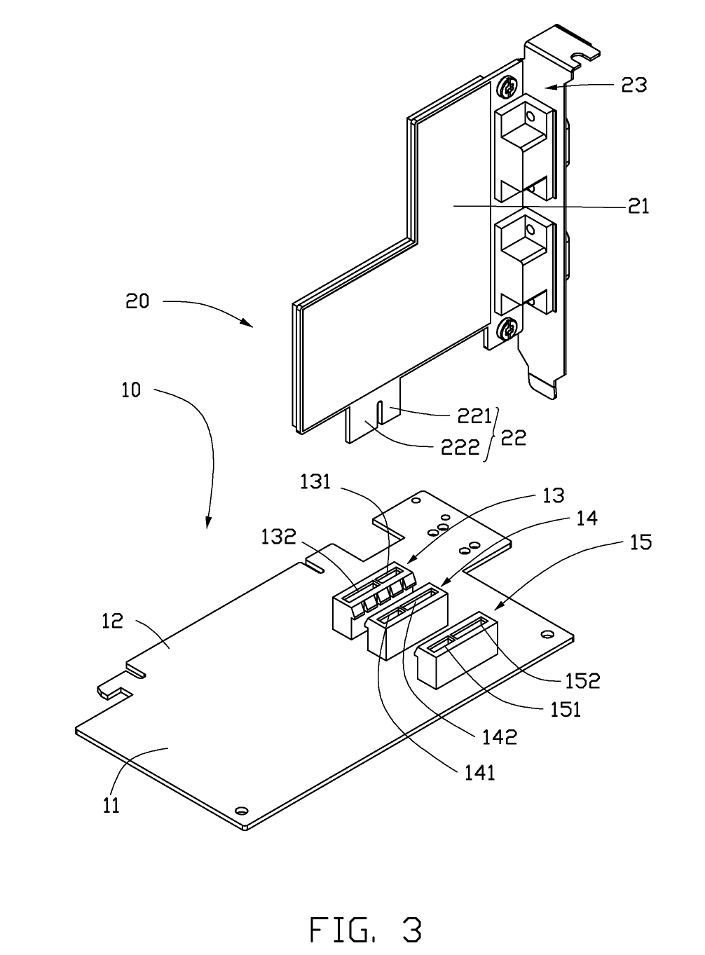

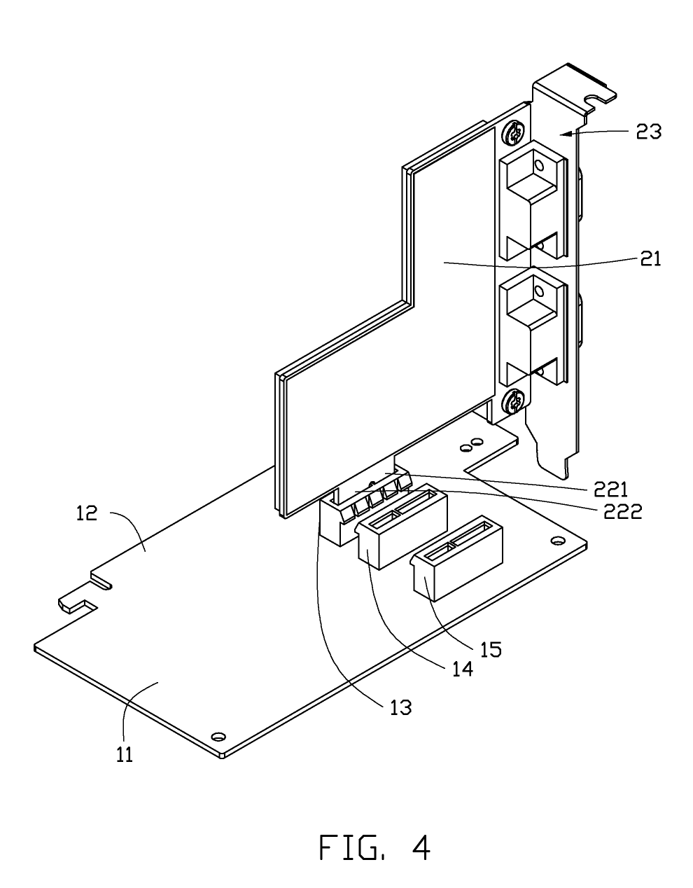

FIGS. 3-4, show a PCI riser card 10 and a PCI expansion card 20 in accordance with an embodiment. The PCI riser card 10 comprises a printed circuit board (PCB) 11 and an array of PCI connectors 13, 14, and 15, etc. A plug portion 12 extends from an edge of the PCB 11 and may be inserted into a PCI connector of a system board (not shown). The array of PCI connectors 13, 14, and 15 is located on a side of the PCB 11. The PCI connectors 13, 14, and 15 are parallel to each other.

Each of the PCI connectors 13, 14, and 15 includes two elongated slots, of which one is longer than the other. Specifically, the PCI connector 13 includes an elongated slot 131 and an elongated slot 132 longer than the elongated slot 131; the PCI connector 14 includes an elongated slot 141 and an elongated slot 142 longer than the elongated slot 141; and the PCI connector 15 includes an elongated slot 151 and an elongated slot 152 longer than the elongated slot 151. The PCI connector 13 is parallel to the PCI connector 14 (or the PCI connector 15) and is arranged in inverse relative to the PCI connector 14 (or the PCI connector 15). Namely, the longer elongated slot 132 of the PCI connector 13 and the shorter elongated slot 141 of the PCI connector 14 are directly across from each other; the shorter elongated slot 131 of the PCI connector 13 and the longer elongated slot 142 of the PCI connector 14 are directly across from each other.

The PCI expansion card 20 includes a PCB 21, a mating portion 22, and a bulkhead 23. The mating portion 22 extends from an edge of the PCB 21. The bulkhead 23 is secured to another edge of the PCB 21. The mating portion 22 may engage with the PCI connector 13 and be connected to the PCI connector 13. Specifically, the mating portion 22 includes a first insertion tab 221 and a second insertion tab 222 longer than the first insertion tab 221. The first insertion tab 221 can fit in the shorter elongated slots 131, 141, and 151. The second insertion tab 222 can only fit in the longer elongated slots 132, 142, and 152. The first insertion tab 221 is nearer to the bulkhead 23 than the second insertion 222. Therefore, the PCI expansion card 20 can only be inserted into the PCI connector 13, and not the PCI connector 14 or the PCI connector 15.

Referring to FIG. 4, in assembly, the PCI expansion card 20 is placed above the PCI connector 13 and the plug portion 22 is aligned with the PCI connector 13. The first insertion tab 221 of the PCI expansion card 20 is inserted into the shorter elongated slot 131. The second insertion tab 222 of the PCI expansion card 20 is inserted into the longer elongated slot 132. The PCI connector 13 may be arranged in a different position of the array of the PCI connectors 13, 14, and 15 thereby forcing a user to plug the PCI expansion card 20 into a specific position of the array of the PCI connectors 13, 14, and 15. In some embodiments, the PCI connector 13 is arranged at the head or the tail of the array of PCI connectors 13, 14, and 15.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A PCI riser card, comprising:
a printed circuit board comprising a plug portion adapted to be inserted into a PCI connector of a system board; and
an array of PCI connectors located on the printed circuit board, the array of PCI connectors comprises a first PCI connector and a second PCI connector, the first PCI connector is parallel to the second PCI connector and is arranged in inverse relative to the second PCI connector.

2. The PCI riser card of claim 1, wherein the first PCI connector comprises a first elongated slot and a second elongated slot, the second elongated slot is longer than the first elongated slot.

3. The PCI riser card of claim 1, wherein the first PCI connector is arranged at a beginning or an end of the array of PCI connectors.

4. A PCI riser card assembly, comprising:
a printed circuit board comprising a plug portion adapted to be inserted into a PCI connector of a system board;
an array of PCI connectors located on the printed circuit board, the array of PCI connectors comprises a first PCI connector and a second PCI connector, the first PCI connector is parallel to the second PCI connector and is arranged in inverse relative to the second PCI connector; and
a PCI expansion card comprising a mating portion adapted to be inserted into the first PCI connector.

5. The PCI riser card assembly of claim 4, wherein the first PCI connector comprises a first elongated slot and a second elongated slot, the second elongated slot is longer than the first elongated slot.

6. The PCI riser card assembly of claim 5, wherein the mating portion comprises a first insertion tab configured to be fitted into the first elongated slot and a second insertion tab configured to be fitted into the second elongated slot.

7. The PCI riser card assembly of claim 4, wherein the first PCI connector is arranged at a beginning or an end of the array of PCI connectors.
